(19) United States
(12) Patent Application Publication
(10) Pub. No.: US 2005/0132848 A1
(43) Pub. Date: Jun. 23, 2005

(54) Eye screw and eye screw socket

(76) Inventors: James Tassano, Sonora, CA (US); Eric L. Willson, Sonora, CA (US)

Correspondence Address: Kevin D. Jablonski, #140, 218 Main St., Kirkland, WA, 98033, US

(21) Appl. No.: 10/742,330

(22) Filed: Dec. 19, 2003

(51) Int. Cl. B25B 13/06

(52) U.S. Cl. 81/121.1

(57) ABSTRACT

An eye screw socket for anchoring an eye screw. An embodiment of the invention is a tool that includes a drive shaft with a longitudinal axis and a cavity attached to one end of the drive shaft, the cavity having an opening operable to hold an eye screw such that the longitudinal axis of the eye screw is deterred from rotating away from the longitudinal axis of the drive shaft. Another embodiment of the invention includes a method for engaging an object with a tool having a cavity attached to a first end of a drive shaft with a longitudinal axis, the cavity having a substantially rectangular opening with a first side length longer than a second side length, the rectangular opening operable to hold an eye screw such that the longitudinal axis of the eye screw is deterred from rotating.

### BACKGROUND OF THE INVENTION

A conventional eye screw typically comprises a screw portion with a rounded eye portion connected to the screw portion. Conventional eye screws are widely used for anchoring a support point to a surface, such as a wall or ceiling, in order to suspend or hold in place any number of objects from the eye portion. The eye portion allows one the convenience of hanging and unhanging objects without having to unanchor the eye screw from the wall or ceiling. This convenience has led to the wide use of eye screws in many applications including, for example, hanging plants, Christmas lights, and television cable.

When anchoring a conventional eye screw to a wall or ceiling, a force in the direction of the longitudinal axis of the screw portion and a rotational torque force are applied to the eye screw such that the screw portion engages the wall or ceiling. That is, the eye screw is screwed into the wall. In some cases, a human hand can provide enough force and rotational torque to engage the threads with the wall. However, this is not always the case and a tool is typically required to increase the amount of vertical force and rotational torque able to be applied to the eye screw. Further, a tool is also required if the location that the eye screw will be installed is not accessible or is beyond the reach (too high, for example) of a human.

One such tool used in the past is a pair of pliers (not shown). Pliers can secure the eye screw 100 in its fingers in order to provide more rotational torque to the eye screw. This tool, however, is only able to rotate as far as the human hand can rotate in one motion before the fingers must release the eye screw and then engage it again before being able to rotate the eye screw again. It is often the case that one rotational motion of the human hand is not enough for the eye screw's threads to engage the surface enough to support its own weight. As such, the eye screw falls out when the fingers of the pliers are released. Furthermore, pliers require one to be in close proximity to the location that the eye screw is being installed. Therefore, pliers are not a viable solution when the location to install the eye screw is a high ceiling.

Another tool that may be used to assist in installing a eye screw is a scalloped interior socket tool (also not shown), such as the one described in U.S. Pat. No. 5,622,090, filed on Apr. 16, 1996 to Marks and assigned to WorkTools, Inc. of Chatsworth, Calif. Using this scalloped interior socket, fingers inside the socket portion retract to form a “pocket” around an object. In this fashion, any shape of object can be engaged and rotational torque can be applied.

The retractable fingers, however, are biased outward. As such, when trying to anchor the eye screw, one must hold the eye screw in the scalloped interior socket when installing. Otherwise the retractable fingers, being biased outward, will push the eye screw out of the scalloped interior socket before one can position the eye screw against the wall. Thus, using a scalloped interior socket will not work for situations when the eye screw must be anchored on a high ceiling where one cannot hold the eye screw in place until the eye screw's threads engage the ceiling.

Furthermore, because the retractable fingers are parallel to the longitudinal axis of the eye screw, the conventional eye screw may rotate away from the longitudinal axis of the scalloped interior socket because the engaged portion of the eye screw is circular in nature. That is, the retractable finger socket does not apply enough force to the eye portion of the eye screw to keep the eye screw from rotating one way or another from the longitudinal axis. As a result, the scalloped interior socket is not capable of maintaining the longitudinal axis of the eye screw in alignment with its own longitudinal axis before the screw portion engages the wall or ceiling.

Therefore, it would be beneficial to have a tool that applies the proper forces to the eye portion of the eye screw in order to maintain parallel longitudinal axes of rotation (both the eye screw's and the tool's) while a eye screw 100 is being anchored.

### SUMMARY OF THE INVENTION

An embodiment of the invention is a tool that includes a drive shaft with a longitudinal axis and a cavity attached to one end of the drive shaft, the cavity having an opening operable to hold an eye screw such that the longitudinal axis of the eye screw is deterred from rotating away from the longitudinal axis of the drive shaft.

Another embodiment of the invention includes a method for engaging an object with a tool having a cavity attached to a first end of a drive shaft with a longitudinal axis, the cavity having a substantially rectangular opening with a first side length longer than a second side length, the rectangular opening operable to hold an eye screw such that the longitudinal axis of the eye screw is deterred from rotating away from the longitudinal axis of the drive shaft and rotating the object about the longitudinal axis of the drive shaft.

By using the tool and method of the present invention, an eye screw can be more easily anchored in a ceiling or wall because the interior walls of the cavity of the eye screw socket will deter the eye screw from rotating away from the longitudinal axis of the drive shaft of the tool. Further, more inaccessible places can be reached using an extension pole and eye screw socket according to another embodiment of the invention.

Yet another embodiment of the invention comprises an eye screw having a shank and a trapezoidal eye portion attached to the shank, the trapezoidal eye portion having an opening formed by four sides, wherein at least two sides comprise parallel straight runs on opposite sides of the opening.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a side view of a trapezoidal eye screw according to an embodiment of the invention;

FIG. 2 is a side view of the trapezoidal eye screw of FIG. 1 and an eye screw socket according to an embodiment of the invention;

FIG. 3 is an isometric view of the eye screw socket of FIG. 2 about to be engaged with the trapezoidal eye screw of FIG. 1 according to an embodiment of the invention; and

FIG. 4 is an exploded view of the eye screw socket of FIG. 2 with an extension pole and mounting handle according to an embodiment of the invention.

### DETAILED DESCRIPTION

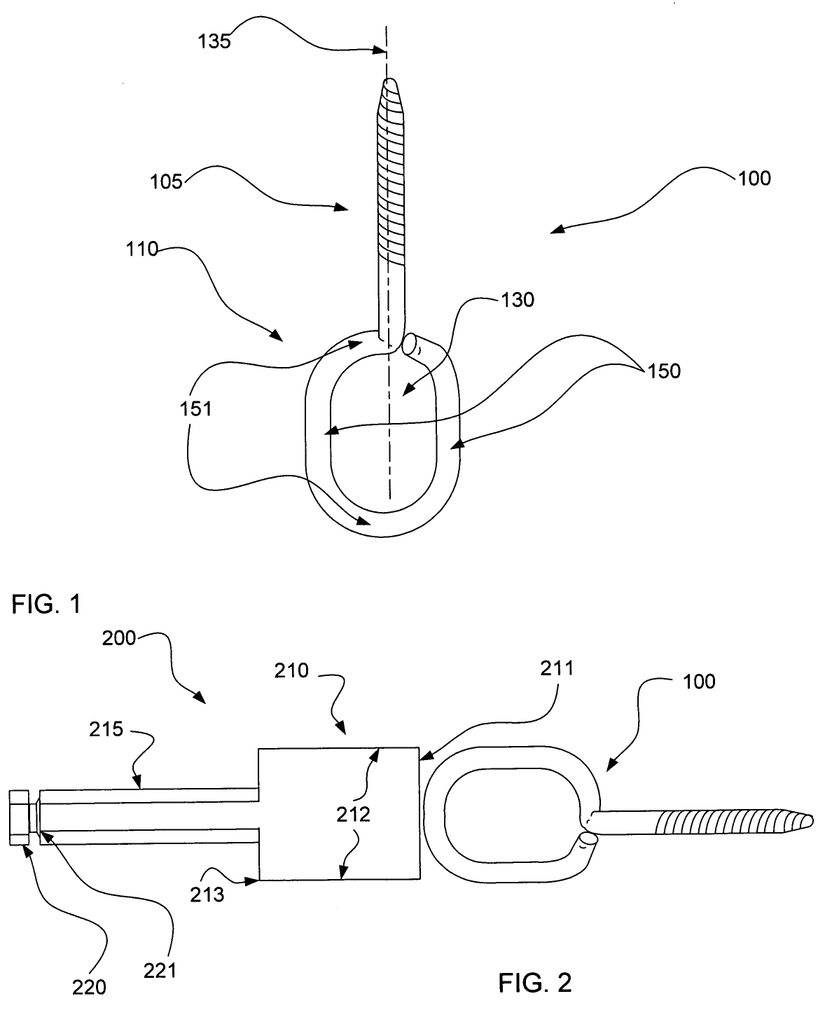

A trapezoidal eye screw 100, shown in FIG. 1, comprises a trapezoidal eye portion 110 (modified to have two straight runs 150 on either side) with a screw attached to it according to an embodiment of the invention. The trapezoidal eye screw 100 of FIG. 1 comprises a threaded (shank) portion 105 and the eye portion 110. The eye portion 110 is further defined by its trapezoidal shape with two parallel straight runs 150 and two curved portions 151 that together form an opening 130. The opening 130 allows an object, such as a cable or rope, to be fed through the eye portion 110 for support.

The trapezoidal eye screw 100 is unique when compared to a conventional eye screw (not shown) in that the two straight runs 150 on either side of the opening 130 of the eye portion 110 provide engagable straight edges for use with a tool operable to engage a trapezoidal eye screw 100.

FIG. 2 is a side view of a trapezoidal eye screw 100 and an eye screw socket 200 according to an embodiment of the invention. The eye screw socket 200 comprises a drive shaft 215 and a socket 210.

The drive shaft 215 is typically hexagonal such that it fits securely in the chuck of a common power drill (not shown). However, any shape, such as square or round, may be used for the shank 215 of the eye screw socket 200. Additionally, the drive shaft 215 may include a notched end 220 separated by a groove 221. The notched end 220 allows the eye screw socket 200 to be used with a typical “quick disconnect” interface with other tools, such as, for example, a ratchet, or an extension pole (also not shown).

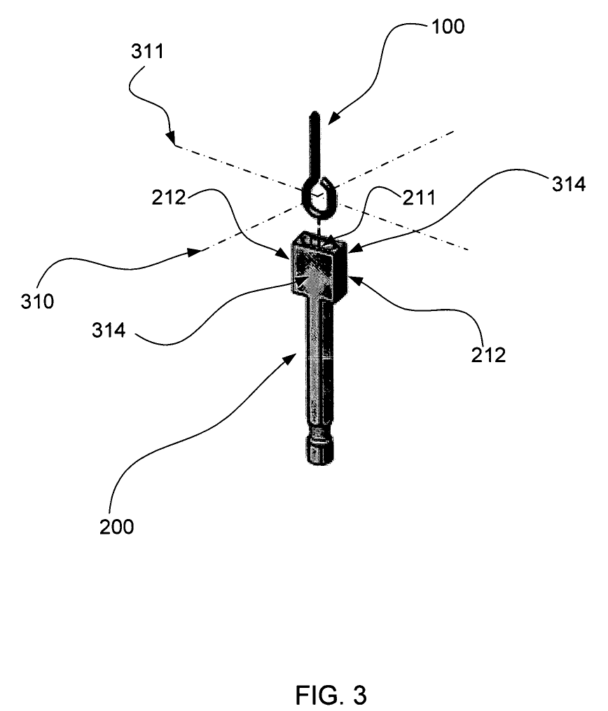

In this embodiment, the eye screw socket 200 is designed to be used with a power drill. Thus, a hexagonal drive shaft 215 is shown that is operable to engage the chuck of a power drill. The drive shaft 215 is coupled to the socket 210 which is designed to engage a typical trapezoidal eye screw 100. The socket 200 includes a cavity or enclosure formed having a rectangular opening 211 formed by a first pair of parallel side walls 212 and a second pair of parallel side walls (not seen easily in FIG. 2). The cavity further includes a back wall 213. These features can also be seen more easily in the isometric view of the eye screw socket 200 in FIG. 3 described below.

Still referring to FIG. 2, the rectangular opening 221 is sufficiently wide enough and long enough to allow a typical trapezoidal eye screw 100 to be inserted into the cavity. The cavity is defined in length by the first pair of parallel side walls 212, in width by the second pair of parallel side walls (as shown in FIG. 3 below), and in depth by the back wall 213 wherein the two sets of parallel walls are adjacent to the rectangular opening 211. The back wall 213 is opposite the rectangular opening 211. In this manner, the interior contour of the cavity of the socket 210 is designed to securely fit a typical trapezoidal eye screw 100.

FIG. 3 is an isometric view of the eye screw socket 200 of FIG. 2 about to be engaged with a trapezoidal eye screw 100 according to an embodiment of the invention. As can be seen more readily in an isometric view, the rectangular opening 211 is defined in length by the first pair of parallel side walls 212 wherein the length is approximately the diameter of the eye portion 110 of a typical trapezoidal eye screw 100. Further, the rectangular opening 211 is defined in width by the second pair of parallel side walls 314 wherein the width is approximately the diameter of the shank 105 of a typical trapezoidal eye screw 100.

The trapezoidal eye screw 100 in FIG. 3 is shown about to be engaged with the eye screw socket 200. When engaged, the cavity of the eye screw socket 200 securely envelops the eye portion 110 of the trapezoidal eye screw 100. As such, the trapezoidal eye screw 100 is deterred from rotating because of the forces applied by the walls (each set of parallel side walls 212 and 314 and the back wall 213) of the interior of the cavity.

In the past, a conventional eye screw easily rotated about one of two horizontal axes 310 and 311 when one attempted to anchor the eye screw to a wall. However, when using the eye screw socket 200 in conjunction with a trapezoidal eye screw 100 the trapezoidal eye screw 100 is deterred from rotating on either of the horizontal axes 310 and 311 because of the forces applied to the eye portion 110 of the trapezoidal eye screw 100 by the interior walls of the cavity of the eye screw socket 200.

For example, if the trapezoidal eye screw 100 begins to rotate along the axis 310 then the parallel walls 212 apply a force against the straight runs 150 of the eye portion 110 of the trapezoidal eye screw 100. Likewise, if the trapezoidal eye screw 100 begins to rotate along the axis 311 then the parallel walls 314 apply a force against the facing (the flat sides) of the eye portion 110 of the trapezoidal eye screw 100. As such, the trapezoidal eye screw 100 is deterred from rotating about any axis when engaged with the eye screw socket 200.

The size of the cavity may be suited to fit any size of trapezoidal eye screw 100. Typical eye screws 100 have lengths that range from approximately 1 inch to 3 inches, dimensions of the eye portion 110 that range from ½ inch to 1.5 inches in both width and length of the trapezoidal opening 130, and thicknesses that range from 0.08 inches to 0.2 inches. The eye screw socket 200 is typically designed to fit one particular size of trapezoidal eye screw 100 in order to securely fit the contour of the eye portion 110 of the trapezoidal eye screw 100. Further, according to one embodiment, the cavity may also include chamfered interior corners so as to better secure the typically rounded portions of some embodiments of the trapezoidal eye screw 100. In this manner, an engaged eye screw 100 is further deterred from rotating.

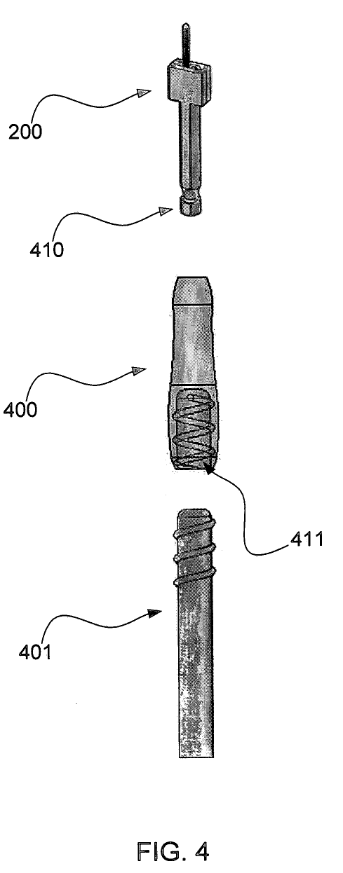

FIG. 4 is an exploded view of the eye screw socket 200 of FIG. 2 with an extension pole mounting handle 400 according to an embodiment of the invention. In this embodiment, the eye screw socket 200 is designed to be mounted on an extension pole for use with working in more inaccessible places. The eye screw socket 200 includes a mounting bracket 410 designed to engage a receptacle 411 in an extension pole mounting handle 400. The extension pole mounting handle 400 is further designed to engage a typical extension pole 401. In one embodiment, the extension pole mounting handle 400 engages the extension pole 401 with threads. Other engagement mechanisms are contemplated but are not disclosed here for brevity.

By using an extension pole 401 with the eye screw socket 200, one can reach more inaccessible places with the eye screw socket 200 for anchoring eye screws 100. For example, trapezoidal eye screws 100 can be anchored on high ceilings or under awnings of a house using an extension pole 401 with an eye screw socket 200.

Other mounting options are contemplated for the eye screw socket 200 but are not shown in the drawings for brevity. For example, the eye screw socket 200 may be mounted in a conventional way to a typical ratchet or wrench. Further, the eye screw socket 200 may be used in conjunction with a drive mechanism, i.e., power drill, ratchet, extension pole, having a jointed drive shaft, i.e., a universal joint. As such, the rotational axis of the drive mechanism may be a different angle than that of the longitudinal axis of the trapezoidal eye screw 100.

From the foregoing it will be appreciated that, although specific embodiments of the invention have been described herein for purposes of illustration, various modifications may be made without deviating from the spirit and scope of the invention.

1. A tool, comprising:
a drive shaft having a longitudinal axis and having a first end and a second opposite end; and
a cavity attached to the first end of the drive shaft, the cavity having an opening operable to hold an eye screw such that the longitudinal axis of the eye screw is deterred from rotating away from the longitudinal axis of the drive shaft.

2. The tool of claim 1, further comprising a polygonal-shaped shaft attached to the second end of the drive shaft and operable to be engaged by a power drill.

3. The tool of claim 1, further comprising a polygonal-shaped shaft attached to the second end of the drive shaft and operable to be engaged by a ratchet.

4. The tool of claim 1, further comprising a handle attached to the second end of the drive shaft and operable to be engaged by a hand.

5. The tool of claim 1 wherein the opening of the cavity is at a first angle to the longitudinal axis of the drive shaft.

6. The tool of claim 5 wherein the opening of the cavity is at a second angle which is perpendicular to the axis or rotation of the first angle.

7. The tool of claim 1 wherein the cavity is operable to engage an eye screw having a substantially circular eye portion with two substantially parallel straight runs.

8. The tool of claim 1, further comprising a universal joint attached between the first end of the drive shaft and the cavity.

9. The tool of claim 1, further comprising an extension pole attached to the second end of the drive shaft.

10. An apparatus, comprising:
a drive shaft having a longitudinal axis and having a first end and a second opposite end;
an engaging enclosure attached to the first end of the drive shaft and operable to an object wherein the engaging enclosure holds the object from rotating away from the longitudinal axis of the drive shaft; and
an extension pole attached to the second end of the drive shaft, the extension pole having a length greater than the reach of a human.

11. The apparatus of claim 10 wherein the size of the opening is sufficient to engage an eye screw having substantially circular eye portion with two substantially parallel straight runs.

12. The apparatus of claim 10 wherein the extension pole is attached to the second end of the drive shaft by means of a quick disconnect device.

13. The apparatus of claim 10, further comprising a handle operable to be engaged by a hand, the handle attached between the second end of the drive shaft and the extension pole.

14. A method, comprising:
engaging an object with a tool having a cavity attached to a first end of a drive shaft with a longitudinal axis, the cavity having a substantially rectangular opening with a first side length longer than a second side length, the rectangular opening operable to hold an eye screw such that the longitudinal axis of the eye screw is deterred from rotating away from the longitudinal axis of the drive shaft; and
rotating the object about the longitudinal axis of the drive shaft.

15. The method of claim 14, further comprising providing the rotating by means of a power drill.

16. The method of claim 14, further comprising providing the rotating by means of a handle.

17. The method of claim 14, further comprising providing the rotating by means of a ratchet.

18. The method of claim 14, further comprising attaching the tool to an extension pole having a length greater than the reach of a human prior to engaging the object.

19. The method of claim 18 wherein the object is beyond the reach of human but within a distance less than or equal to the length of the extension pole.

20. An eye screw, comprising:
a shank; and
a trapezoidal eye portion attached to the shank, the trapezoidal eye portion having an opening formed by four sides, wherein at least two sides comprise parallel straight runs on opposite sides of the opening.

21. The eye screw of claim 20 wherein the shank further comprises threads.

22. The eye screw of claim 20 wherein the opening further comprises two sides that are curved sides, the curved sides coupled between the parallel straight runs.

23. The eye screw of claim 20 wherein the opening further comprises two sides coupled between the parallel straight runs that are also parallel straight runs.

24. The eye screw of claim 20, wherein the trapezoidal eye portion is operable to be engaged by an eye screw socket, the eye screw socket comprising:
a drive shaft having a longitudinal axis and having a first end and a second opposite end; and
a cavity attached to the first end of the drive shaft, the cavity having an opening operable to hold an eye screw such that the longitudinal axis of the eye screw is deterred from rotating away from the longitudinal axis of the drive shaft.
